(19) United States
(12) Patent Application Publication
(10) Pub. No.: US 2017/0000296 A1
(43) Pub. Date: Jan. 5, 2017

(54) Water Container and Holder Structure

(71) Applicant: Hsiao-Chin Wang, Taipei City (TW)

(72) Inventor: Hsiao-Chin Wang, Taipei City (TW)

(21) Appl. No.: 14/754,920

(22) Filed: Jun. 30, 2015

(51) Int. Cl. A47K 1/09; F16B 1/00

(52) U.S. Cl. CPC A47K 1/09; F16B 1/00; F16B 2001/0035; F16B 2001/0028

(57) ABSTRACT

A water container and holder structure includes: a container body and a holder capable of being secured onto an intended vertical face or wall surface. The holder includes a horizontally projecting extending portion and a receiving space with an opening at the top thereof. The receiving space is used for holding toothbrushes that are not in use. The bottom of the receiving space includes a sloping bottom surface, and a hollow slot is provided at the lowest level of the sloping bottom surface for water drainage. The bottom of the extending portion is provided with a coupling element, and the bottom of the container body is provided with a coupled element that can be easily coupled with (magnetically attracted to or “hook-and-loop” fastened with) the coupling element, such that the container body is conveniently received underneath the extending portion of the holder in an upside down position.

### BACKGROUND OF THE INVENTION

1. Field of the Invention

The invention relates to a water container and holder structure, and more particularly, to a water container and holder structure that is easy to use and promotes hygiene by allowing the container to be stored upside down.

2. Description of the Prior Art

In our modern daily life, toothbrushes and tumblers are indispensable necessities, and for hygiene reason, everyone should have their own toothbrushes and tumblers in order to avoid the risk of bacterial infection. Tumbler products are generally stand-alone cup-shaped containers for holding water required for mouthwash. However, such a cup-shaped structure of the tumbler may have the following shortcomings:

1. A tumbler is usually placed upright on the sink after being used. Although people usually empty their tumblers after brushing their teeth, very often residual water still remains in the cups, which encourages germ growth.

2. In order to prevent bacterial contamination of the head portion of the toothbrush, it is advised to keep the head portion away from making contact with other things after being used. However, toothbrushes normally comes without any upright mechanisms. As a result, after the toothbrush is used, it is very often placed in the tumbler. By doing so, the germs growing inside the tumbler may also contaminate the toothbrush. This adversely affects personal hygiene.

3. In order to effectively prevent bacterial contamination of the toothbrush from the germs inside the tumbler, a more feasible approach is to provide a dedicated storage mechanism for each toothbrush. However, this is bound to take up the limited space of the sink, resulting in an inefficient utilization of space.

For this reason, a titled “Tumbler Holder” was disclosed before, which includes: a strong suction module that can be attached on the wall. The suction module has a toothbrush-fitting hole and a lug-fitting hole. The toothbrush-fitting hole allows a toothbrush to be inserted therein for storage. A tumbler includes a lug that can be inserted into the lug-fitting hole so the tumbler can be hanged upside down on the suction module to allow water to be drained. However, as the tumbler is held inside the lug-fitting hole through the lug, the weight of the tumbler itself may tilt the lug, which in turns may cause the tumbler to slip and fall off. Furthermore, the tumbler is prone to titling upon gentle touch and fails to maintain in a fully inverted position at all time, so complete drainage cannot be ensured. Moreover, the suction module is poor in terms of space utilization as it is only capable of accommodating one toothbrush at a time.

In view of the shortcomings in the conventional tumbler holders and associated rigid structures, the present invention is proposed to provide improvements that address these shortcomings.

### SUMMARY OF THE INVENTION

One main objective of the present invention is to provide a water container and holder structure that ensures the container body is inverted when stored, so as to allow residual water to be drained completely from the container body, and in turn reduces bacterial contamination of the container body.

Another objective of the present invention is to provide a water container and holder structure that provides a storage mechanism for toothbrushes, thus improving overall space utilization.

Still another objective of the present invention is to provide a water container and holder structure that is overall easy to use.

In order to achieve the above objectives and efficacies, the technical means employed by the present invention may include: a holder including a securing portion to be secured on an intended vertical face and a projecting extending portion with a coupling element provided at the bottom of the extending portion; and a container body including a coupled element at the bottom thereof that is coupled to the coupling element, wherein the container body is stored underneath the extending portion of the holder in a upside down position.

Based on the above structure, the holder includes a receiving space having an opening at the top thereof.

Based on the above structure, the receiving space includes a sloping bottom surface at the bottom thereof, and the sloping bottom surface includes a hollow slot at its lowest level.

Based on the above structure, the coupling and coupled elements are selected from one of a pair of magnetically attracted bodies or a hook-and-loop fastener.

Based on the above structure, the extending portion includes a concave space at the bottom thereof, and the inner periphery of the concave space is provided with an inner peripheral groove, and the periphery of the coupling element is provided with correspondingly projecting latching portions that are embedded into the inner peripheral groove, such that the coupling portion is secured to the bottom of the extending portion.

Based on the above structure, the container body includes a concave space at the bottom thereof, and the inner periphery of the concave space is provided with an inner peripheral groove, and the periphery of the coupled element is provided with a correspondingly projecting peripheral flange that is embedded into the inner peripheral groove, such that the coupled element is secured to the bottom of the container body.

Based on the above structure, the holder is secured onto the intended vertical face via a flat securing component.

The objectives, efficacies and features of the present invention can be more fully understood by referring to the drawing as follows:

### BRIEF DESCRIPTION OF THE DRAWINGS

FIG. 1 is an exploded view of the structure in accordance with the present invention.

FIG. 2 is a schematic diagram illustrating the assembly of a coupling element and a holder in accordance with the present invention.

FIG. 3 is a schematic diagram illustrating the overall assembly of the structure in accordance with the present invention.

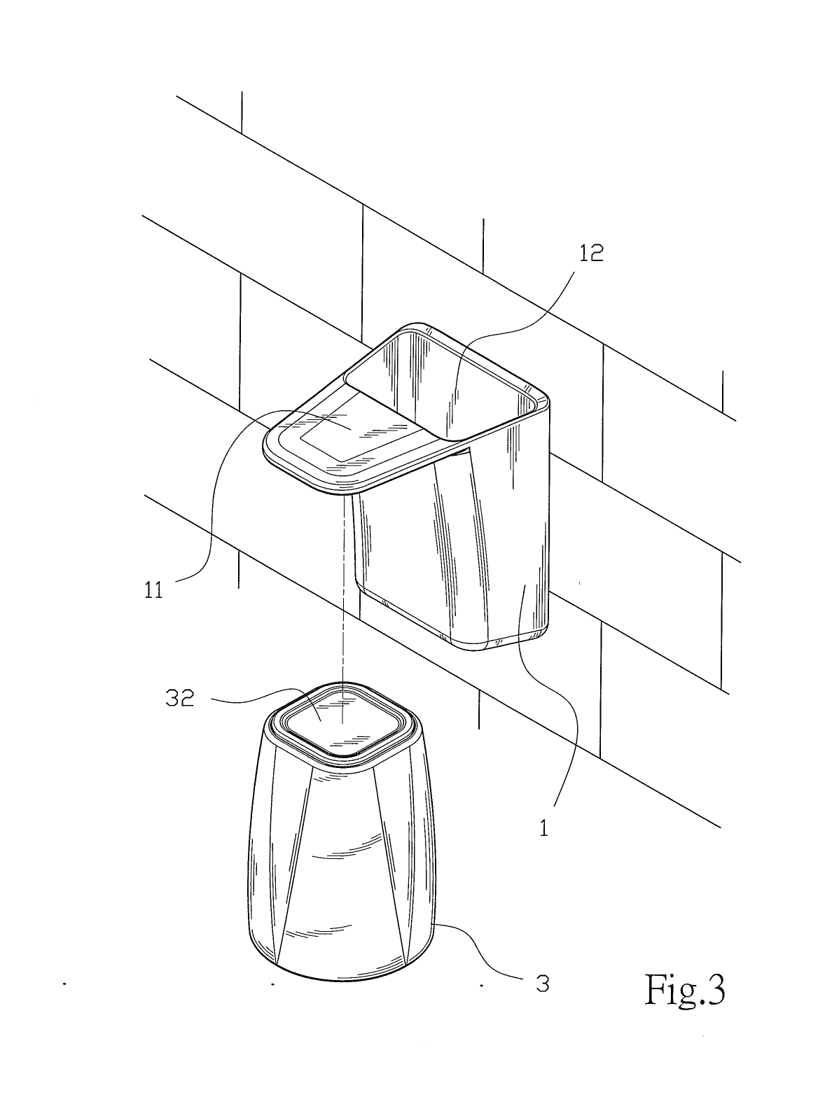

FIG. 4 is a schematic diagram illustrating the structure in accordance with the present invention before the container is stored.

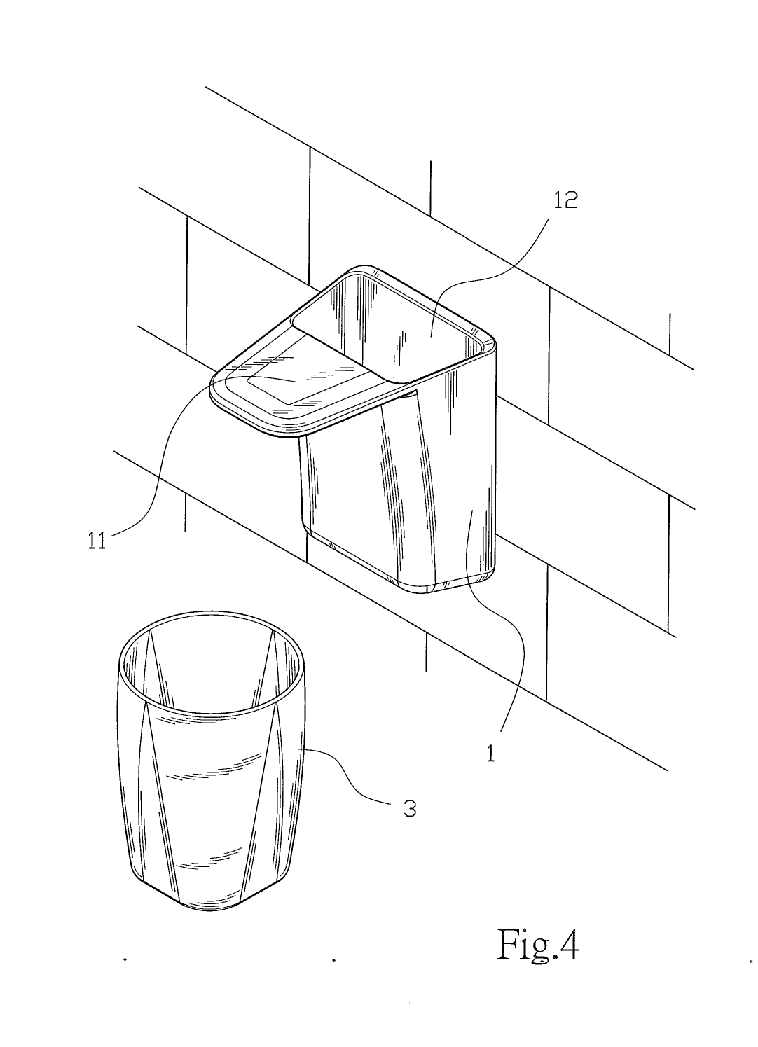

FIG. 5 is a perspective view of the structure in accordance with the present invention after the container is stored.

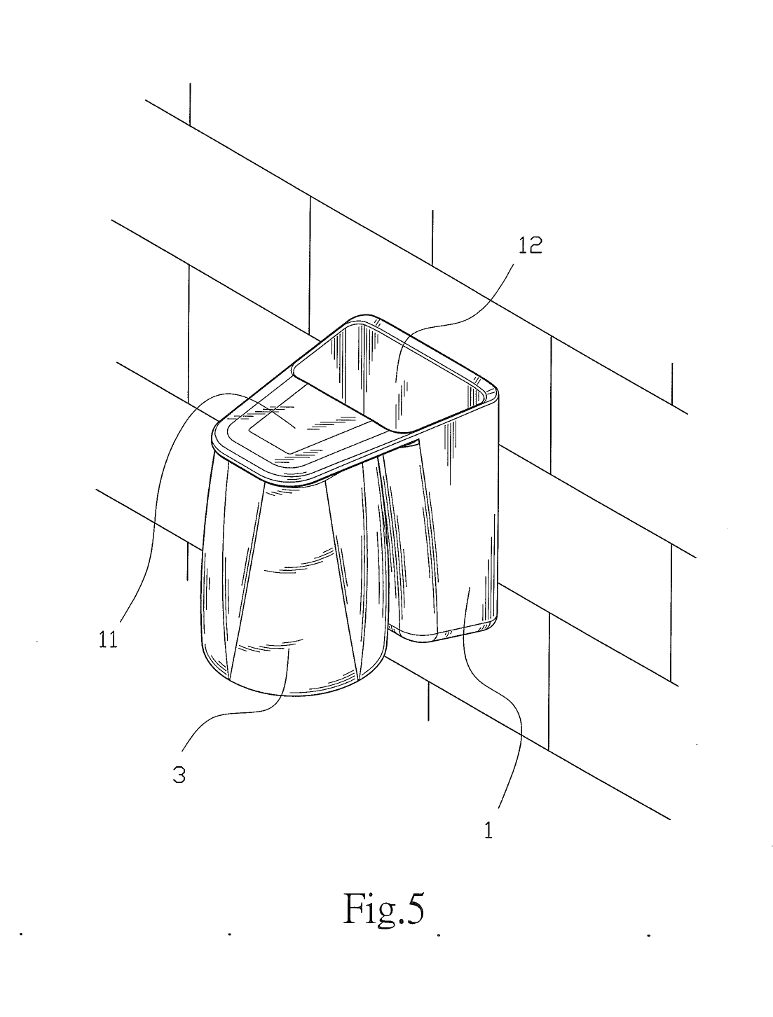

### DETAILED DESCRIPTION OF THE PREFERRED EMBODIMENTS

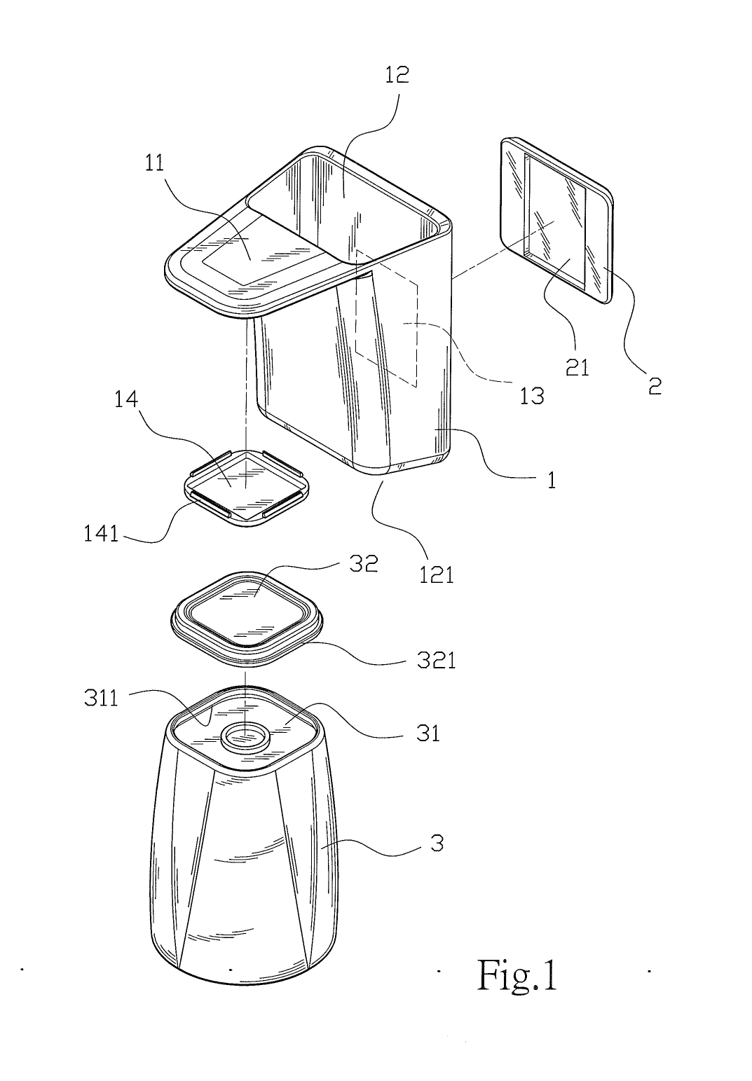

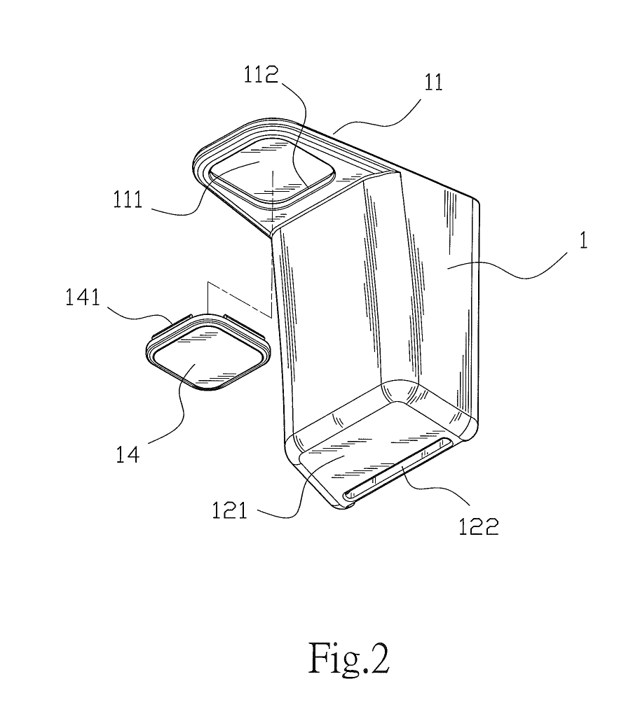

Referring to FIGS. 1 and 2, the present invention essentially includes: a holder 1 and a container body 3, wherein the holder 1 includes a receiving space 12 having an opening at the top and an extending portion 11 that extends horizontally. The receiving space 12 includes a sloping bottom surface 121, which has a hollow slot 122 at the lowest part. The extending portion 11 includes a concave space 111 at the bottom for receiving a coupling element 14. There is an inner peripheral groove 112 along the inner periphery of the concave space 111. The coupling element 14 can, for example, be a magnetic body or the hook portion (or the loop portion) of a hook-and-loop fastener with a plurality of elastic projecting latching portions 141 (such as hooks) along its periphery. The latching portions 141 are embedded into the inner peripheral groove 112, such that the coupling element 14 can be secured to the bottom of the extending portion 11. In addition, a securing portion 13 is provided at a surface of the holder 1 and to be secured onto an intended vertical face or wall surface. The container body 3 is a container for holding water. A concave space 31 is provided at the bottom of the container body 3 for receiving a coupled element 32. An inner peripheral groove 311 is provided along the inner periphery of the concave space 31. The coupled element 32 can, for example, be a magnetic body or the loop portion (or the hook portion) of the hook-and-loop fastener with a peripheral flange 321 around its periphery. The peripheral flange 321 is inserted into the inner peripheral groove 311, such that the coupled element 32 can be fixed to outer bottom surface of the container body 3.

In practice, the holder 1 may be adhered to the intended vertical face or wall surface directly with the securing portion 13 (such as a double-sided tape), or with a flat securing component 2. The securing component 2 may be first adhered (with a double-sided tape) or screwed onto the intended vertical face or wall surface. The securing component 2 includes a concaving recess 21 for receiving a magnetic body or the hook portion (or the loop portion) of a hook-and-loop fastener, while the securing portion 13 of the holder 1 correspondingly includes a magnetic body or the loop portion (or the hook portion) of the hook-and-loop fastener. As such, the holder 1 can be detachably or permanently secured to the intended vertical face or wall surface. When in use, the receiving space 12 of the holder 1 provides storage for any toothbrush that is not being used (or after it is being used). The residual water on the toothbrush are guided along the sloping bottom surface 121 at the bottom of the receiving space 12 and let out through the hollow slot 122, thus reducing germ growth inside the receiving space 12. After finishing using the container body 3, the container body 3 can be inverted and the coupled element 32 at the bottom thereof is coupled (magnetically attracted or “hook-and-loop” fastened) to the coupling element 14, so that the container body 3 can be stored upside down below the extending portion 11 of the holder 1. In addition to providing an efficient storage mechanism, the container body 3 being held upside down also means the water can be drained out completely, prevent germ from growing inside the container body 3. Moreover, the coupled element 32 and the coupling element 14 are positioned and secured together via magnetic suction or fabric fastening mechanism, making it easy to use.

From the above, it is clear that the water container and holder structure of the present invention allows easy storage and promotes hygiene by facilitating drying of the container body and the toothbrush receiving space, and it thus submitted to be novel and non-obvious and a patent application is hereby filed in accordance with the patent law.

It should be noted that the descriptions given above are merely descriptions of preferred embodiments of the present invention, various changes, modifications, variations or equivalents can be made to the invention without departing from the scope or spirit of the invention. It is intended that all such changes, modifications and variations fall within the scope of the following appended claims and their equivalents.

What is claimed is:

1. A water container and holder structure, comprising:
a holder including a securing portion to be secured on an intended vertical face and a projecting extending portion with a coupling element provided at the bottom of the extending portion; and
a container body including a coupled element at the bottom thereof that is coupled to the coupling element, wherein the container body is stored underneath the extending portion of the holder in a upside down position.

2. The water container and holder structure of claim 1, wherein the holder includes a receiving space having an opening at the top thereof.

3. The water container and holder structure of claim 2, wherein the receiving space includes a sloping bottom surface at the bottom thereof, and the sloping bottom surface includes a hollow slot at its lowest level.

4. The water container and holder structure of claim 3, wherein the coupling and coupled elements are selected from one of a pair of magnetically attracted bodies or a hook-and-loop fastener.

5. The water container and holder structure of claim 3, wherein the extending portion includes a concave space at the bottom thereof, and the inner periphery of the concave space is provided with an inner peripheral groove, and the periphery of the coupling element is provided with correspondingly projecting latching portions that are embedded into the inner peripheral groove, such that the coupling portion is secured to the bottom of the extending portion.

6. The water container and holder structure of claim 4, wherein the extending portion includes a concave space at the bottom thereof, and the inner periphery of the concave space is provided with an inner peripheral groove, and the periphery of the coupling element is provided with correspondingly projecting latching portions that are embedded into the inner peripheral groove, such that the coupling portion is secured to the bottom of the extending portion.

7. The water container and holder structure of claim 3, wherein the container body includes a concave space at the bottom thereof, and the inner periphery of the concave space is provided with an inner peripheral groove, and the periphery of the coupled element is provided with a correspondingly projecting peripheral flange that is embedded into the inner peripheral groove, such that the coupled element is secured to the bottom of the container body.

8. The water container and holder structure of claim 4, wherein the container body includes a concave space at the bottom thereof, and the inner periphery of the concave space is provided with an inner peripheral groove, and the periphery of the coupled element is provided with a correspondingly projecting peripheral flange that is embedded into the inner peripheral groove, such that the coupled element is secured to the bottom of the container body.

9. The water container and holder structure of claim 3, wherein the holder is secured onto the intended vertical face via a flat securing component.

10. The water container and holder structure of claim 4, wherein the holder is secured onto the intended vertical face via a flat securing component.

11. The water container and holder structure of claim 2, wherein the coupling and coupled elements are selected from one of a pair of magnetically attracted bodies or a hook-and-loop fastener.

12. The water container and holder structure of claim 2, wherein the extending portion includes a concave space at the bottom thereof, and the inner periphery of the concave space is provided with an inner peripheral groove, and the periphery of the coupling element is provided with correspondingly projecting latching portions that are embedded into the inner peripheral groove, such that the coupling portion is secured to the bottom of the extending portion.

13. The water container and holder structure of claim 2, wherein the container body includes a concave space at the bottom thereof, and the inner periphery of the concave space is provided with an inner peripheral groove, and the periphery of the coupled element is provided with a correspondingly projecting peripheral flange that is embedded into the inner peripheral groove, such that the coupled element is secured to the bottom of the container body.

14. The water container and holder structure of claim 2, wherein the holder is secured onto the intended vertical face via a flat securing component.

15. The water container and holder structure of claim 1, wherein the coupling and coupled elements are selected from one of a pair of magnetically attracted bodies or a hook-and-loop fastener.

16. The water container and holder structure of claim 15, wherein the extending portion includes a concave space at the bottom thereof, and the inner periphery of the concave space is provided with an inner peripheral groove, and the periphery of the coupling element is provided with correspondingly projecting latching portions that are embedded into the inner peripheral groove, such that the coupling portion is secured to the bottom of the extending portion.

17. The water container and holder structure of claim 15, wherein the container body includes a concave space at the bottom thereof, and the inner periphery of the concave space is provided with an inner peripheral groove, and the periphery of the coupled element is provided with a correspondingly projecting peripheral flange that is embedded into the inner peripheral groove, such that the coupled element is secured to the bottom of the container body.

18. The water container and holder structure of claim 1, wherein the extending portion includes a concave space at the bottom thereof, and the inner periphery of the concave space is provided with an inner peripheral groove, and the periphery of the coupling element is provided with correspondingly projecting latching portions that are embedded into the inner peripheral groove, such that the coupling portion is secured to the bottom of the extending portion.

19. The water container and holder structure of claim 1, wherein the container body includes a concave space at the bottom thereof, and the inner periphery of the concave space is provided with an inner peripheral groove, and the periphery of the coupled element is provided with a correspondingly projecting peripheral flange that is embedded into the inner peripheral groove, such that the coupled element is secured to the bottom of the container body.

20. The water container and holder structure of claim 1, wherein the holder is secured onto the intended vertical face via a flat securing component.
